(19) United States
(12) Patent Application Publication
(10) Pub. No.: US 2026/0123655 A1
(43) Pub. Date: May 7, 2026

(54) METHOD FOR MANUFACTURING SOLID GOCHUJANG

(71) Applicant: SIMPLY, Hanam-si (KR)

(72) Inventor: YOUNG HWA LEE, Yangju-si (KR)

(73) Assignee: SIMPLY, Hanam-si (KR)

(21) Appl. No.: 19/029,972

(22) Filed: Jan. 17, 2025

(30) Foreign Application Priority Data
Nov. 4, 2024 (KR) 10-2024-0154189

(51) Int. Cl. A23L 19/00; A23B 7/02; A23B 7/04; A23B 9/08; A23B 9/10; A23B 75/00; A23L 7/10; A23L 11/50; A23L 27/14

(52) U.S. Cl. CPC A23L 19/09; A23B 7/02; A23B 7/0433; A23B 9/08; A23B 9/10; A23B 75/00; A23L 7/198; A23L 11/50; A23L 27/14

(57) ABSTRACT

A method for manufacturing solid gochujang according to a disclosed embodiment includes evaporating moisture from gochujang that has fluidity by containing moisture, and cooling the gochujang that has fluidity equal to or less than a predetermined threshold as the moisture is evaporated.

### CROSS REFERENCE TO RELATED APPLICATION

The present application claims the right of priority to and the benefits of Korean Application No. 10-2024-0154189 having a filing date of Nov. 4, 2024, the content of which is hereby incorporated by reference in its entirety.

### TECHNICAL FIELD

The present disclosure relates to solid gochujang (i.e., solid red pepper paste) and a method for manufacturing solid gochujang.

### BACKGROUND

Gochujang is traditional Korean spicy paste with a reddish color, made by mixing fermented soybean powder, red pepper powder, salt, and so on with wet cooked rice made with rice, barely, or the like, rice cake powder, or hard-boiled porridge. Since such gochujang contains moisture and is in a semi-liquid state at room temperature, there is a problem in that the gochujang has to be distributed and stored in an airtight container or the like. In addition, since the gochujang, which is contained in the container in a semi-liquid state, is poured by using a spoon or the like and transferred to a cooking container, there is a problem in that the periphery of the cooking container is contaminated due to the sticky gochujang that spills during transfer, and in the process of pouring the gochujang by using the spoon or the like, sugar, soy sauce, various seasonings, and the like, which are stuck in the spoon or the like, are inevitably stuck in the gochujang remaining in the container, thereby causing bacteria to reproduce in the gochujang remaining in the container.

### SUMMARY

The present disclosure provides solid gochujang and a method for manufacturing the same, in which gochujang is solidified without changing its original flavor and characteristics, so that the gochujang is easily distributed and stored, hygienic, and convenient to use.

One aspect of the present disclosure provides a method for manufacturing solid gochujang including evaporating moisture from gochujang that has fluidity by containing moisture, and cooling the gochujang that has fluidity equal to or less than a predetermined threshold as the moisture is evaporated.

In an embodiment, the evaporating moisture may include putting the gochujang into a chamber, making an interior of the chamber into a vacuum state, and heating the gochujang in the vacuum state.

In an embodiment, in the making the interior of the chamber into the vacuum state, an internal pressure of the chamber may be set to 0.001 to 1 mbar.

In an embodiment, in the heating the gochujang, a temperature of the gochujang may be set to 55° C. to 80° C.

In an embodiment, in the heating the gochujang, the gochujang may be heated for 2 to 3.5 hours.

In an embodiment, in the heating the gochujang, the gochujang may be stirred with a stirrer while heating the gochujang.

In an embodiment, in the heating the gochujang, the fluidity of the gochujang may be determined by detecting a pressure applied to the stirrer, and the gochujang may be heated until the fluidity of the gochujang is equal to or less than the predetermined threshold.

In an embodiment, in the cooling the gochujang, the gochujang may be cooled at −20° C. to −18° C. for 0.5 to 1 hour.

In an embodiment, in the cooling the gochujang, the gochujang may be cooled by shaping the gochujang.

In an embodiment, in the cooling the gochujang, the gochujang may be shaped into a plate with a thickness of 3 to 3.4 mm.

### BRIEF DESCRIPTION OF THE DRAWINGS

FIGS. 1A and 1B are flowcharts showing a method for manufacturing solid gochujang according to one embodiment of the present disclosure.

FIG. 2 is a photograph showing solid gochujang manufactured according to the method for manufacturing solid gochujang according to one embodiment of the present disclosure.

FIG. 3 is a photograph showing a packed state of the solid gochujang manufactured according to the method for manufacturing solid gochujang according to one embodiment of the present disclosure.

FIG. 4 is a photograph showing a state of unpacking the solid gochujang manufactured according to the method for manufacturing solid gochujang according to one embodiment of the present disclosure.

FIG. 5 is a photograph showing an unpacked state of the solid gochujang manufactured according to the method for manufacturing solid gochujang according to one embodiment of the present disclosure.

### DETAILED DESCRIPTION

Embodiments of the present disclosure are illustrated for the purpose of explaining the technical idea of the present disclosure. The scope of the rights according to the present disclosure is not limited to the embodiments presented below or the detailed descriptions of such embodiments.

All technical and scientific terms used in the present disclosure have the meaning generally understood by those of ordinary skill in the art to which the present disclosure pertains, unless otherwise defined. All terms used in the present disclosure are chosen for the purpose of more clearly describing the present disclosure and are not chosen to limit the scope of rights according to the present disclosure.

As used in the present disclosure, expressions such as “comprising”, “including”, “having”, and the like are to be understood as open-ended terms having the possibility of encompassing other embodiments, unless otherwise mentioned in the phrase or sentence containing such expressions.

The singular form described in the present disclosure may include a plural meaning, unless otherwise mentioned. This applies equally to the singular form recited in the claims.

The terms “first”, “second”, and the like used in the present disclosure are used to distinguish a plurality of components from one another, and do not limit the order or importance of the corresponding components.

The terms used herein are only for the purpose of describing particular embodiments and are not intended to limit the present disclosure.

Hereinafter, embodiments of the present disclosure will be described in detail with reference to the accompanying drawings. The same reference numeral will be used for the same element throughout the drawings, and duplicate descriptions of the same element will be omitted.

Firstly, the method for manufacturing solid gochujang according to one embodiment of the present disclosure will be described.

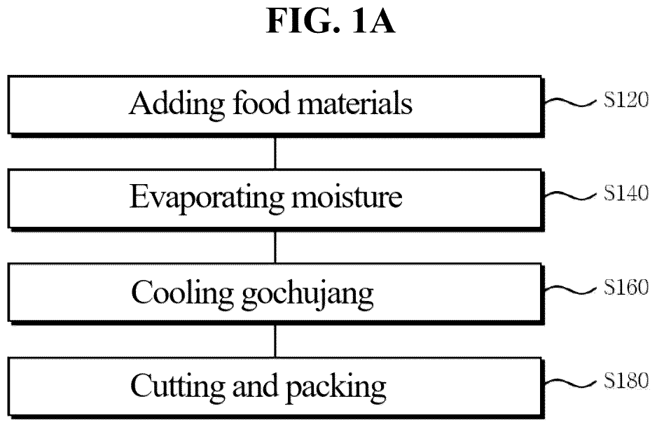

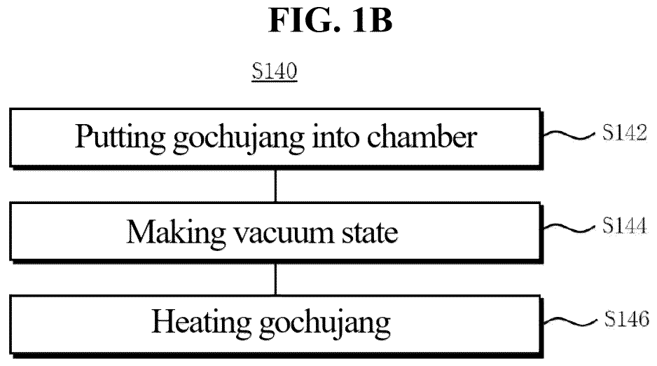

According to the present embodiment, as shown in FIG. 1A, the method for manufacturing solid gochujang includes a step S140 of evaporating moisture from gochujang that has fluidity by containing moisture, and a step S160 of cooling the gochujang that has fluidity equal to or less than a predetermined threshold as the moisture is evaporated.

Hereinafter, steps of the method for manufacturing solid gochujang according to the present embodiment will be described with reference to FIGS. 1A to 5.

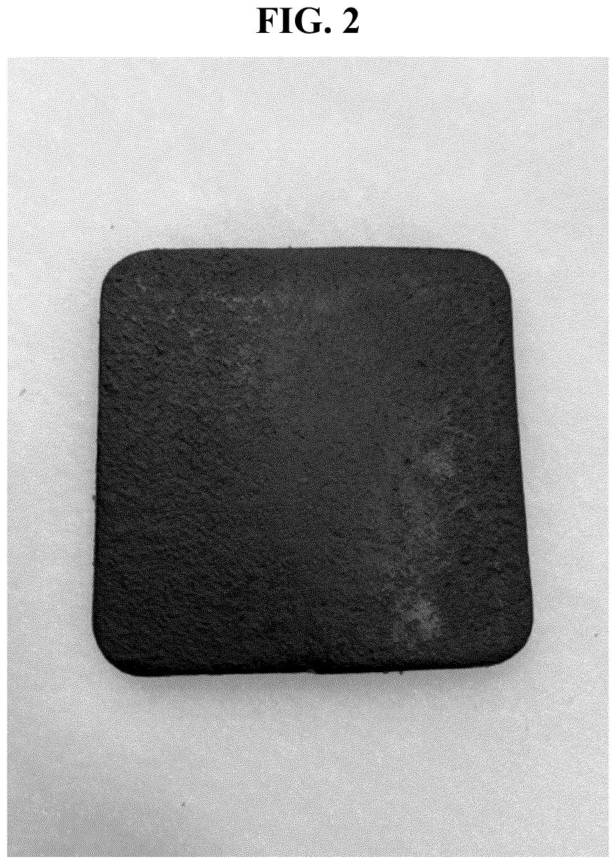

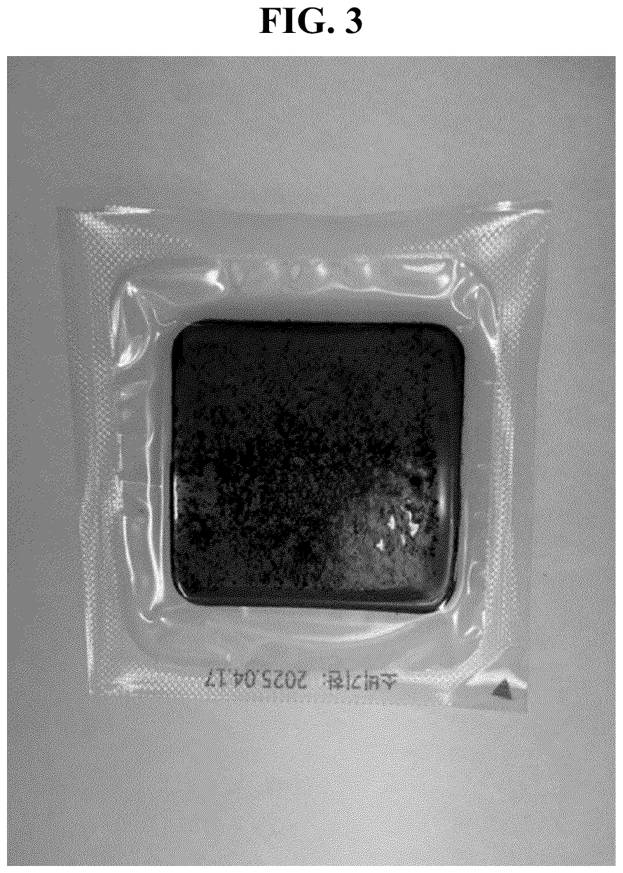

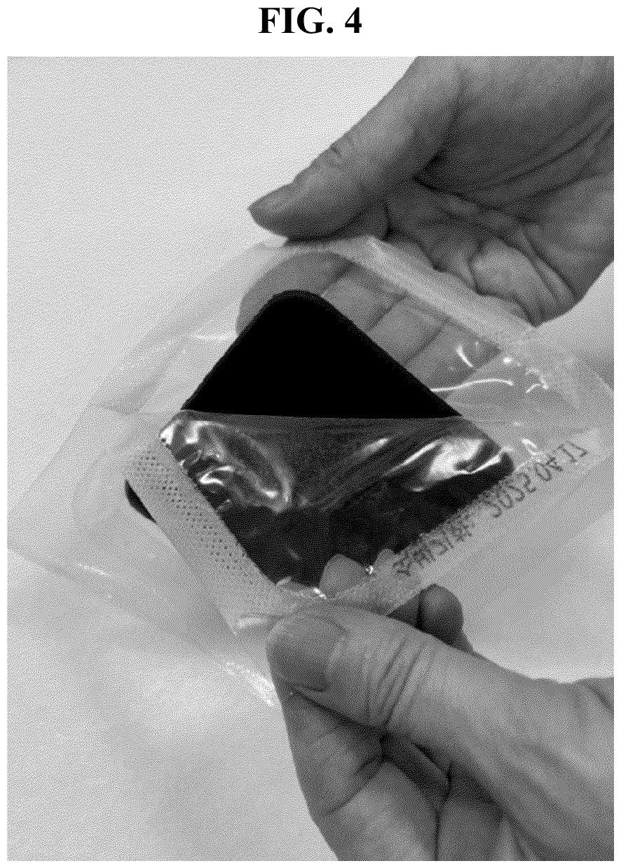

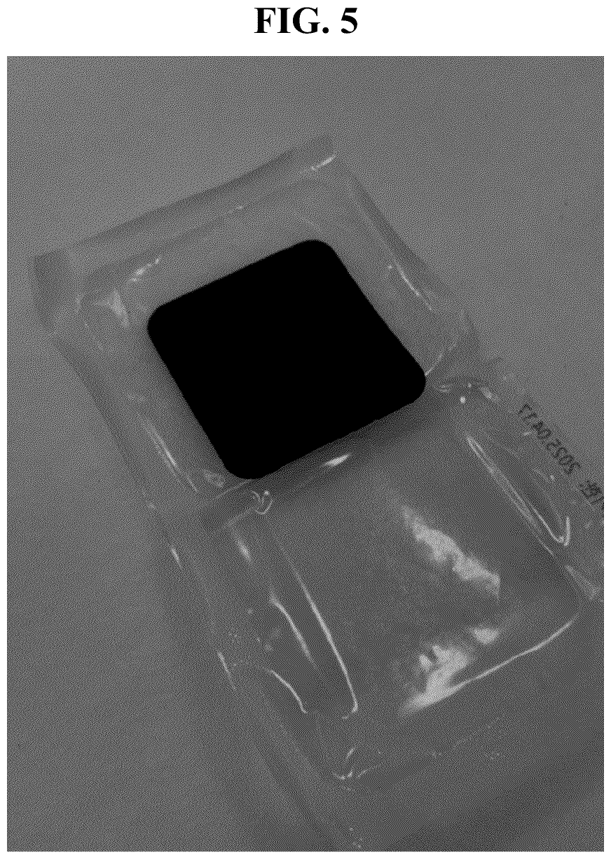

FIGS. 1A and 1B area flowchart showing a method for manufacturing solid gochujang according to one embodiment of the present disclosure, FIG. 2 is a photograph showing solid gochujang manufactured according to the method for manufacturing solid gochujang according to one embodiment of the present disclosure, FIG. 3 is a photograph showing a packed state of the solid gochujang manufactured according to the method for manufacturing solid gochujang according to one embodiment of the present disclosure, FIG. 4 is a photograph showing a state of unpacking the solid gochujang manufactured according to the method for manufacturing solid gochujang according to one embodiment of the present disclosure, and FIG. 5 is a photograph showing an unpacked state of the solid gochujang manufactured according to the method for manufacturing solid gochujang according to one embodiment of the present disclosure.

In step S140, moisture is evaporated from gochujang that has fluidity due to moisture.

Although there are some differences in ingredients, ratios, and physical properties of each product, the gochujang is generally viscous and contains moisture, thereby making the gochujang fluid.

By evaporating only the moisture contained in the gochujang, the fluid gochujang may be solidified without changing its original flavor and characteristics.

Accordingly, the solid gochujang (i.e., solidified gochujang) may be easily distributed and stored and may be conveniently used for cooking. the solid gochujang may express the flavor and characteristics of the gochujang as a cooking material.

Meanwhile, the solid gochujang used in the present embodiment may be a commercially available product.

A first embodiment of the step S140 of evaporating the moisture will be described.

The first embodiment is carried out under an atmospheric pressure condition unlike a second embodiment to be described later.

Referring to FIG. 1A, the step S140 of evaporating the moisture may include a step of putting the gochujang into a container and a step S146 of heating the gochujang by heating the container.

Specifically, in the step S146 of heating the gochujang, a temperature of the gochujang may be set to 80° C. to 90° C.

In this case, in the step S146 of heating the gochujang, the gochujang may be heated for 5.5 to 6.5 hours.

By heating the gochujang such that the temperature of the gochujang is maintained at least 80° C., an evaporation rate of the moisture contained in the gochujang can be increased.

In this case, the moisture contained in the gochujang can be sufficiently evaporated in about 5 hours 30 minutes to 6 hours 30 minutes.

When the temperature of the gochujang is lower than 80° C., a time required to evaporate the moisture from the gochujang can be relatively too long.

When the temperature of the gochujang exceeds 90° C., the gochujang is boiled or cooked so that flavor and characteristics of the gochujang can be changed, and as a result of cooking the gochujang, the gochujang may become a finished food rather than a seasoning, unlike the object of the present embodiment.

Therefore, the gochujang is heated such that the temperature of the gochujang is maintained at 80° C. to 90° C. for 5.5 to 6.5 hours, thereby allowing the moisture contained in the gochujang to be evaporated as quickly as possible while maintaining the flavor and characteristics of the gochujang.

Next, the second embodiment of the step S140 of evaporating the moisture will be described.

The step S140 of evaporating the moisture may include a step S142 of putting the gochujang into a chamber, a step S144 of making an interior of the chamber into a vacuum state, and a step S146 of heating the gochujang in the vacuum state.

Unlike the above-described first embodiment, by heating the gochujang in a vacuum state lower than an atmospheric pressure, a temperature for evaporating the moisture contained in the gochujang can be lowered and a time required to heat the gochujang can be shortened, and accordingly, a change in ingredients of the gochujang due to heating may be prevented or reduced to solidify the gochujang while more effectively maintaining the flavor and characteristics of the gochujang.

The gochujang may be put into the chamber after being put into the container, and the gochujang may be heated by heating the container containing the gochujang, increasing an internal temperature of the chamber, or irradiating the interior of the chamber with microwaves.

In the step S144 of making the interior of the chamber into the vacuum state, an internal pressure of the chamber may be set to 0.001 to 1 mbar.

In this case, in the step S146 of heating the gochujang, the temperature of the gochujang may be set to 55° C. to 80° C. (preferably, 60° C. to 70° C.).

In this case, in the step S146 of heating the gochujang, the gochujang may be heated for 2 to 3.5 hours (preferably, 2.5 to 3 hours).

By making a vacuum state where the internal pressure of the chamber is equal to or less than 1 mbar, the temperature of the gochujang for evaporating the moisture contained in the gochujang may be lowered and the evaporation rate of the moisture contained in the gochujang may be increased.

When the internal pressure of the chamber exceeds 1 mbar, the temperature of the gochujang can be relatively too high and the time required to evaporate moisture can be relatively too long.

It is possible to make a vacuum state where the internal pressure of the chamber is equal to or greater than 0.00 1 mbar by using a simple mechanical pump or the like. However, making a vacuum state where the internal pressure of the chamber is less than 0.001 mbar requires a more precise mechanical pump and other expensive production facilities, thereby increasing production costs and reducing production efficiency.

By heating the gochujang such that the temperature of the gochujang is maintained at 55° C. in a vacuum state where the internal pressure of the chamber is 0.001 to 1 mbar, the evaporation rate of the moisture contained in the gochujang can be increased.

In this case, the moisture contained in the gochujang can be sufficiently evaporated in about 2 hours to 3 hours 30 minutes.

When the temperature of the gochujang is lower than 55° C., a time required to evaporate the moisture from the gochujang may be relatively too long.

When the temperature of the gochujang exceeds 80° C., there is a greater possibility that the flavor and characteristics of the gochujang may be relatively changed.

Therefore, by heating the gochujang such that the temperature of the gochujang is maintained at 55° C. to 80° C. for 2 to 3.5 hours in a vacuum state where the internal pressure of the chamber is 0.001 to 1 mbar after putting the gochujang into the chamber, it is possible to lower the temperature of the gochujang for evaporating the moisture from the gochujang and to shorten the time required to heat the gochujang within the most reasonable productivity range in terms of production costs and production efficiency, and accordingly, it is possible to solidify the gochujang while more effectively maintaining the flavor and characteristics of the gochujang by preventing or reducing a change in ingredients of the gochujang due to heating.

The following descriptions may be commonly applied to the above-described embodiments of the step S140 of evaporating the moisture.

In the step S146 of heating the gochujang, the gochujang may be stirred with a stirrer while heating the gochujang.

By stirring the gochujang by using the stirrer such as a spatula while heating the gochujang, the gochujang may be prevented from burning by allowing sufficient heat exchange inside the gochujang.

In the step S146 of heating the gochujang, the fluidity of the gochujang may be determined by detecting a pressure applied to the stirrer, and the gochujang may be heated until the fluidity of the gochujang is equal to or less than the predetermined threshold.

When the moisture is evaporated from the gochujang, the fluidity of the gochujang is decreased, and thus a pressure (load) applied to the stirrer may be increased when stirring the gochujang with the stirrer.

When the fluidity of the gochujang determined by the pressure applied to the stirrer reaches a predetermined threshold, it may be considered that the moisture contained in the gochujang is evaporated to a level necessary for solidification of the gochujang.

Specifically, the predetermined threshold may be equivalent to a fluidity comparable to that of approximately 10 slices of cheese or SPAM. For example, the pressure applied to the stirrer when the fluidity of the gochujang reaches the predetermined threshold is equivalent to a pressure applied to the stirrer when pressing approximately 10 slices of cheese or SPAM.

When stirring the stirrer by using a mechanical device or the like, it is possible to determine whether the fluidity of the gochujang is equal to or less than the predetermined threshold by detecting the pressure applied to the stirrer using a pressure sensor or the like.

Before the step S140 of evaporating the moisture, a step S120 of adding food materials including oat dietary fiber, lentil beans, and a seasoning material to the gochujang may be further included.

The oat dietary fiber contains a lot of proteins, is easy to digest upon consumption due to its high fat and fiber content, and contains a large amount of beta-glucan, which lowers the blood sugar level and cholesterol level in blood to help prevent cardiovascular diseases such as arterial stiffness, and improves lipid metabolism to prevent body fat accumulation.

The lentil beans are rich in protein, dietary fiber, and nutrients and antioxidants such as folic acid, vitamin B1, phosphorus, iron, and phenolic acid, have excellent digestive absorption rate, and high protein and dietary fiber content, which helps antioxidant and anti-cancer effects, aging prevention, immunity enhancement, and constipation prevention, lowers the cholesterol level to prevent cardiovascular diseases, is effective for diet with high protein and low calorie, and is good for anemia because the lentil beans contain a large amount of iron and folic acid.

The seasoning material may be regarded as a food material used to enhance or adjust the flavor of the gochujang.

When the solid gochujang manufactured according to the present embodiment is used for cooking, the seasoning for the cooking may be made together by the seasoning material included in the solid gochujang.

Specifically, the seasoning material may include soy flour, wheat flour, garlic powder, onion powder, and salt.

In the step S120 of adding the food materials, specifically, food materials including 3 parts by weight of oat dietary fiber, 1 part by weight of lentil bean, and greater than 0 and less than 1 part by weight of seasoning material may be added to greater than 95 and less than 96 parts by weight of gochujang.

Meanwhile, in step S160, the gochujang that has fluidity equal to or less than the predetermined threshold is cooled as the moisture is evaporated.

The gochujang is solidified by cooling the gochujang from which the moisture is evaporated such that the fluidity is equal to or less than the predetermined threshold and in which heat remains due to heating for the evaporation.

In the step S160 of cooling the gochujang, the gochujang may be cooled at −20° C. to −18° C. for 0.5 to 1 hour.

As described above, when cooling the gochujang, the gochujang is cooled in a frozen state of −20° C. to −18° C. for 0.5 to 1 hour, thereby increasing a cooling speed of the gochujang and more easily processing and packing the solidified gochujang.

In the step S160 of cooling the gochujang, the gochujang may be cooled by shaping the gochujang.

The gochujang, which has heat remaining due to heating, is in a state of taffy with high viscosity, so that the gochujang may be shaped to hold a shape thereof.

Specifically, the gochujang may be cooled and hardened by putting the same into a standard mold or a shaping frame.

In the step S160 of cooling the gochujang, the gochujang may be shaped into a plate with a thickness of 3 to 3.4 mm.

The gochujang may be made into a slice shape by shaping the same into a plate, and thus the solidified gochujang may be easily processed and packed, conveniently used in various foods such as slice cheese, and easily cut by hand without a knife or scissors and the like.

In particular, since the gochujang is shaped into a plate with a thickness of 3 to 3.4 mm, the gochujang may be easily dissolved or loosened in water within a range in which a shape of the gochujang is maintained at room temperature, and may be easily handled such as by cutting well.

After the step S160 of cooling the gochujang, a step S180 of cutting the gochujang into a predetermined size and packing the same may be further included.

Referring to FIGS. 2, 3, and the like, specifically, the gochujang, which is shaped into a plate, cooled, and solidified, may be cut into a predetermined size like a slice cheese, and then individually packed.

Referring to FIGS. 4, 5, and the like, in this case, the solid gochujang may be used by putting or adding the solid gochujang into a dish after easily opening or removing the package without directly touching the solid gochujang.

The package may be in the form of sealing the solid gochujang (e.g., vacuum package) to prevent the solid gochujang from being exposed to moisture as shown in FIG. 3, and the like, and may be in the form that may be easily torn or removed by hand without using scissors or the like as shown in FIGS. 4, 5, and the like.

Meanwhile, after cutting the gochujang into a predetermined size, the cut gochujang may be passed through a metal detector before packing.

A plurality of individually packed solid gochujangs may be further packed in one package and distributed, stored, and used.

The solid gochujang manufactured according to the present embodiment can be stored at room temperature, and can be more effective in shape maintenance and convenience of use when stored in a refrigerator.

### Examples and Comparative Examples

For a sensory evaluation of the solid gochujang manufactured according to the present embodiment, Examples 1 and 2 were prepared under the same conditions but different heating pressures and heating temperatures, and Comparative Examples 1 and 2 were prepared under the same conditions but different heating temperatures and slice thicknesses.

TABLE 1

| | | | | | Comparative | | Comparative | |
|---|---|---|---|---|---|---|---|---|
| | Embodiment 1 | | Embodiment 2 | | Example 1 | | Example 2 | |
| Heating pressure | Atmospheric pressure | | Vacuum 0.01 mbar | | Vacuum 0.01 mbar | | Vacuum 0.01 mbar | |
| Heating temperature | 85° | C. | 65° | C. | 85° | C. | 65° | C. |
| Heating time | 6 | Hours | 2 Hours 40 minutes | | 2 Hours 40 minutes | | 2 Hours 40 minutes | |
| Cooling temperature | −19° | C. | −19° | C. | −19° | C. | −19° | C. |
| Cooling time | 40 | Minutes | 40 | Minutes | 40 | Minutes | 40 | Minutes |
| Slice thickness | 3.2 | mm | 3.2 | mm | 3.2 | mm | 4.0 | mm |

### <Sensory Evaluation>

The sensory evaluation was performed for a total of 20 testers by giving a score relative to a 5-point scale method (5: very good, 4: good, 3: normal, 2: poor, 1: very poor) for color, taste, flavor, reproducibility, and convenience of the Embodiment 1, the Embodiment 2, the Comparative Example 1, and the Comparative Example 2, and the results thereof are shown in Table 2 below (the score is rounded off to an average value).

The reproducibility refers to a degree to which the solid gochujang is dissolved or loosened in water when the solid gochujang is put into water, and the convenience refers to a degree to which the solid gochujang is convenient to be handled, such as whether the solid gochujang is stained on the hand or is not easily cut.

TABLE 2

| | | | Comparative | Comparative |
|---|---|---|---|---|
| | Embodiment 1 | Embodiment 2 | Example 1 | Example 2 |
| Color | 3 | 5 | 4 | 5 |
| Taste | 3 | 5 | 4 | 5 |
| Flavor | 3 | 5 | 4 | 5 |
| Reproducibility | 5 | 5 | 5 | 3 |
| Convenience | 5 | 5 | 5 | 3 |

Referring to Table 2, it can be seen that Embodiment 2 received the highest score in all items.

Comparing the results of Embodiment 2 and Embodiment 1, it can be seen that heating the gochujang in a vacuum state has an important influence on the color, taste, and flavor of the solid gochujang.

Comparing the results of Embodiment 2 and Comparative Example 1, it can be seen that the temperature of heating the gochujang has an important influence on the color, taste, and flavor.

Comparing the results of Embodiment 2 and Comparative Example 2, it can be seen that the thickness of shaping the gochujang has an important influence on the reproducibility and convenience.

Next, solid gochujang according to one embodiment of the present disclosure will be described.

According to the present embodiment, as shown in FIGS. 1A, 1B, 2, and the like, there is provided solid gochujang that is manufactured according to the manufacturing method including a step S140 of evaporating moisture from gochujang that has fluidity due to the moisture, and a step S160 of cooling the gochujang that has fluidity equal to or less than a predetermined threshold as the moisture is evaporated.

According to the present embodiment as described above, it is possible to provide solid gochujang in which gochujang is solidified without changing original flavor and characteristics thereof, so that the gochujang is easily distributed and stored, hygienic, and convenient to use.

In addition, the solid gochujang manufactured according to the present embodiment is free from external temperatures and is easy to pack, thereby protecting the environment, and the solid gochujang manufactured according to the present embodiment is solid, so that the packaging may be made various and luxurious.

Hereinafter, solid gochujang according to the present embodiment will be described with reference to FIGS. 1 to 5.

In step S140, moisture may be evaporated from gochujang that has fluidity due to the moisture.

The step S140 of evaporating the moisture may include a step S142 of putting the gochujang into a chamber, a step S144 of making an interior of the chamber into a vacuum state, and a step S146 of heating the gochujang in the vacuum state.

In the step S144 of making the interior of the chamber into the vacuum state, an internal pressure of the chamber may be set to 0.001 to 1 mbar.

In this case, in the step S146 of heating the gochujang, the temperature of the gochujang may be set to 55° C. to 80° C. (preferably, 60° C. to 70° C.).

In this case, in the step S146 of heating the gochujang, the gochujang may be heated for 2 to 3.5 hours (preferably, 2.5 to 3 hours).

In the step S146 of heating the gochujang, the gochujang may be stirred with a stirrer while heating the gochujang.

In the step S146 of heating the gochujang, the fluidity of the gochujang may be determined by detecting a pressure applied to the stirrer, and the gochujang may be heated until the fluidity of the gochujang is equal to or less than the predetermined threshold.

Before the step S140 of evaporating the moisture, a step S120 of adding food materials including oat dietary fiber, lentil beans, and a seasoning material to the gochujang may be further included.

Specifically, the seasoning material may include soy flour, wheat flour, garlic powder, onion powder, and salt.

In the step S120 of adding the food materials, specifically, food materials including 3 parts by weight of oat dietary fiber, 1 part by weight of lentil bean, and greater than 0 and less than 1 part by weight of seasoning material may be added to greater than 95 and less than 96 parts by weight of gochujang.

Meanwhile, in step S160, the gochujang that has fluidity equal to or less than the predetermined threshold may be cooled as the moisture is evaporated.

In the step S160 of cooling the gochujang, the gochujang may be cooled at −20° C. to −18° C. for 0.5 to 1 hour.

In the step S160 of cooling the gochujang, the gochujang may be formed and cooled.

In the step S160 of cooling the gochujang, the gochujang may be shaped into a plate with a thickness of 3 to 3.4 mm.

After the step S160 of cooling the gochujang, a step S180 of cutting the gochujang into a predetermined size and packing the same may be further included.

Specifically, the gochujang, which is shaped into a plate, cooled, and solidified, may be cut into a predetermined size like a slice cheese, and then individually packed.

The package may be in the form of sealing the solid gochujang to prevent the solid gochujang from being exposed to moisture, and may be in the form that may be easily torn or removed by hand without using scissors or the like.

A plurality of individually packed solid gochujangs may be further packed in one package and distributed, stored, and used.

Details of the method for manufacturing solid gochujang according to the present embodiment may follow the above-described method for manufacturing solid gochujang according to one embodiment of the present disclosure.

According to an embodiment of the present disclosure, it is possible to provide solid gochujang and a method for manufacturing the same, in which gochujang is solidified without changing original flavor and characteristics thereof, so that the gochujang is easily distributed and stored, hygienic, and convenient to use.

The solid gochujang manufactured according to the present embodiment can be free from an external temperature and easy to pack, thereby protecting the environment. In addition, since the solid gochujang manufactured according to the present embodiment is solid, a package thereof can be made various and luxurious.

The technical idea of the present disclosure has been described heretofore with reference to some embodiments and examples illustrated in the accompanying drawings. However, it is to be understood that various substitutions, modifications, and alterations may be made without departing from the technical idea and scope of the present disclosure that can be understood by those of ordinary skill in the technical field to which the present disclosure pertains. In addition, it is to be understood that such substitutions, modifications, and alterations fall within the scope of the appended claims.

What is claimed is:

1. A method for manufacturing solid gochujang, comprising:
evaporating moisture from gochujang that has fluidity by containing moisture; and
cooling the gochujang that has fluidity equal to or less than a predetermined threshold as the moisture is evaporated.

2. The method of claim 1, wherein the evaporating moisture includes:
putting the gochujang into a chamber;
making an interior of the chamber into a vacuum state; and
heating the gochujang in the vacuum state.

3. The method of claim 2, wherein in the making the interior of the chamber into the vacuum state, an internal pressure of the chamber is set to 0.001 to 1 mbar.

4. The method of claim 3, wherein in the heating the gochujang, a temperature of the gochujang is set to 55° C. to 80° C.

5. The method of claim 4, wherein in the heating the gochujang, the gochujang is heated for 2 to 3.5 hours.

6. The method of claim 2, wherein in the heating the gochujang, the gochujang is stirred with a stirrer while heating the gochujang.

7. The method of claim 6, wherein in the heating the gochujang, the fluidity of the gochujang is determined by detecting a pressure applied to the stirrer, and the gochujang is heated until the fluidity of the gochujang is equal to or less than the predetermined threshold.

8. The method of claim 1, wherein in the cooling the gochujang, the gochujang is cooled at −20 to −18° C. for 0.5 to 1 hour.

9. The method of claim 1, wherein in the cooling the gochujang, the gochujang is cooled by shaping the gochujang.

10. The method of claim 9, wherein in the cooling the gochujang, the gochujang is shaped into a plate with a thickness of 3 to 3.4 mm.
